(19) United States
(12) Patent Application Publication
(10) Pub. No.: US 2009/0307044 A1
(43) Pub. Date: Dec. 10, 2009

(54) System and method for consolidation of calendar appointments

(76) Inventors: Al Chakra, Apex, NC (US); Melvin R. Jones, JR., Chapel Hill, NC (US); Julie A. Meserve, Raleigh, NC (US)

Correspondence Address: IBM RALEIGH IPLAW (DG);C/O DELIZIO GILLIAM, PLLC, 15201 MASON ROAD, SUITE 1000-312, CYPRESS, TX, 77433, US

(21) Appl. No.: 12/136,506

(22) Filed: Jun. 10, 2008

(51) Int. Cl. G06F 9/46

(52) U.S. Cl. 705/9

(57) ABSTRACT

A system and method for dynamically consolidating an appointment schedule. The system includes a client computer, a calendar server, and a server calendar management agent (CMA). The client computer displays a calendar user interface to show a first candidate appointment. The calendar server facilitates a scheduling consolidation session. The server CMA searches for a second candidate appointment for consolidation with the first candidate appointment based on at least one consolidation parameter. The server CMA also identifies a consolidated appointment for at least the first and second candidate appointments. The consolidated appointment combines the first and second candidate appointments according to the consolidation parameter.

### BACKGROUND

Scheduling meetings on conventional calendar software typically relies on user knowledge and/or input to place entries on the calendar in an efficient fashion. Automated assistance is limited, however, to such functions as checking for available time slots on a meeting chairperson's calendar and verifying the available time slot with the calendars of invited participants.

A common scenario that occurs during multiple meeting scheduling sessions is different meeting chairpersons opening their respective calendaring systems and scheduling their meetings unaware of any potential overlapping of meeting topics, participants, locations, etc. For example, a first chairperson scheduling a first meeting on topic X may invite invitees A, B, and C to attend. A second chairperson scheduling a second meeting on topic Y may invite participants A, B, C, D, and the first chairperson. Each chairperson opens their own calendaring system to look through various dates and times for available time slots and sends invitations to invited participants, unaware of any potential overlapping meeting topics, invitees, etc. This lack of coordinating, although inadvertent, can create significant scheduling inefficiencies because each chairperson attends several meetings scheduled throughout the day and each scheduled meeting interrupts other tasks.

A known solution to address these scheduling inefficiencies is to manually search for and modify appointments with common participants, locations, and topics. For example, the first chairperson scheduling the first meeting examines other calendar entries for the day, week, or month to personally look for potential scheduling efficiencies. Likewise, the second chairperson may personally look for potential scheduling efficiencies as well. Also, manually reviewing various meeting times, locations, and participant lists is a time-consuming process. However, the drawbacks of human intervention are that the efficiencies may be overlooked. Moreover, the additional step of scanning for efficiencies is often simply bypassed.

### SUMMARY

Embodiments of a system are described. In one embodiment, the system dynamically consolidates an appointment schedule. The system includes a client computer, a calendar server, and a server calendar management agent (CMA). The client computer displays a calendar user interface to show a first candidate appointment. The calendar server facilitates a scheduling consolidation session. The server CMA searches for a second candidate appointment for consolidation with the first candidate appointment based on at least one consolidation parameter. The server CMA also identifies a consolidated appointment for at least the first and second candidate appointments. The consolidated appointment combines the first and second candidate appointments according to the consolidation parameter. Other embodiments of the system are also described.

Embodiments of a method for dynamically consolidating an appointment schedule are also described. In one embodiment, the method includes displaying a calendar user interface to show a first candidate appointment. The method also includes searching for a second candidate appointment for consolidation with the first candidate appointment based on at least one consolidation parameter. The method also includes identifying a consolidated appointment for at least the first and second candidate appointments. The consolidated appointment combines the first and second candidate appointments according to the consolidation parameter. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a calendaring system.

FIG. 2 depicts a schematic block diagram of one embodiment of a client computer that is substantially similar to the nodes of the calendaring system of FIG. 1.

FIG. 3A depicts an exemplary embodiment of a calendar user interface and a scheduling session on the client computer of FIG. 2.

FIG. 3B depicts an exemplary embodiment of a consolidation menu for use with the calendar user interface of FIG. 3A.

FIG. 3C depicts an exemplary embodiment of a recurring consolidation schedule interface for use with the calendar user interface of FIG. 3A.

FIG. 4 depicts a schematic block diagram of one embodiment of the calendar server of the calendaring system of FIG. 1.

FIG. 5 depicts a schematic flow chart diagram of one embodiment of a single meeting consolidation method for the consolidation of the single meeting with other associated meetings during a scheduling session.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments facilitate dynamically consolidating scheduled meeting times in a calendar system. The calendar system may incorporate a scheduling session in which the correlations of scheduled meetings are displayed to a chairperson and/or a list of participants to the meeting. In one embodiment, the display includes correlation data associated with scheduled meetings such as overlapping and associated meeting topics, overlapping invited participants, overlapping locations, etc. A calendar management agent (CMA) provides the correlation data to the meeting chairperson such as proposed meeting consolidations and proposed meeting time to increase the efficiency of two or more meetings as well as productivity of the meeting participants. In some embodiments, the CMA provides the meeting chairperson a list of proposed meeting consolidations and efficiency enhancements, and allows the meeting chairperson to selectively implement the proposed meeting consolidations and efficiencies. Other embodiments are also described below with specific reference to the corresponding figures.

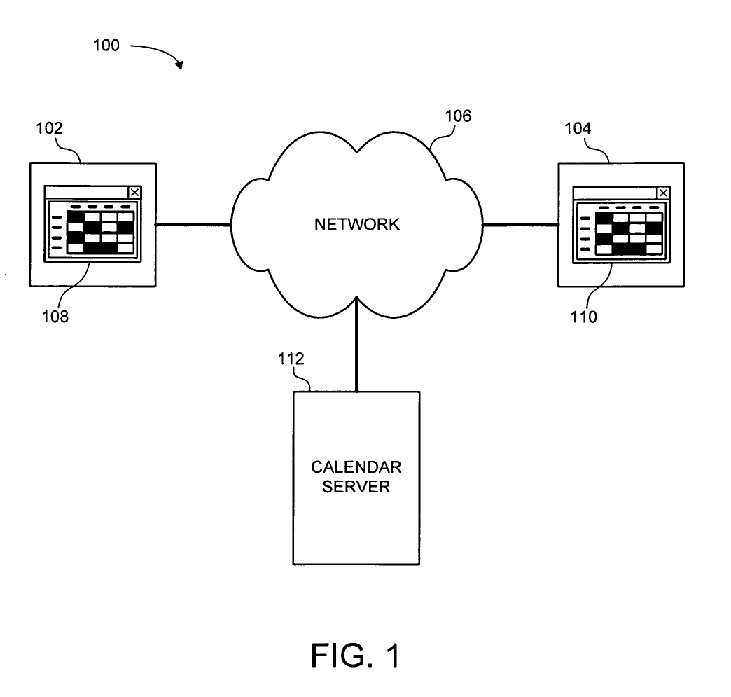

FIG. 1 depicts a schematic block diagram of one embodiment of a calendaring system 100. The illustrated calendaring system 100 includes multiple nodes 102 and 104 connected together via a computer communication network such as the internet 106. The nodes 102 and 104 are also referred to, in some instances, as client computers 102 and 104. Each of the nodes 102 and 104 may be referred to as a sending node and/or a receiving node, depending on the direction of data flow between the nodes 102 and 104 at any given time. It should also be noted that the calendaring system 100 may include more than two nodes. Each node 102 and 104 implements a calendar client (represented by the depicted calendar user interfaces 108 and 110) so that a scheduling session may be realized between the calendar clients.

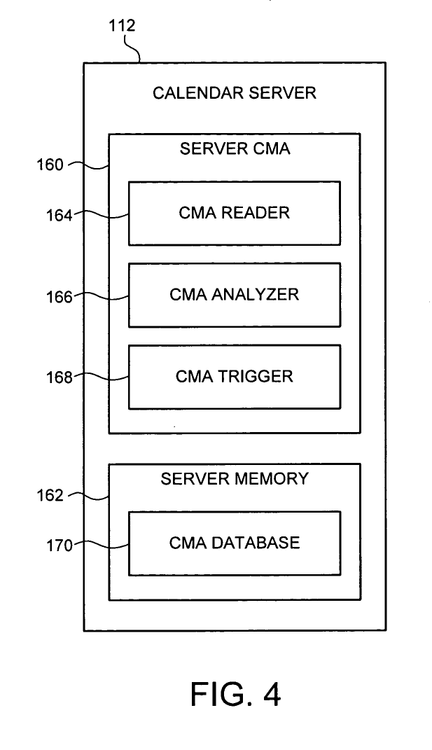

The illustrated calendaring system 100 also includes a calendar server 112 to facilitate the scheduling session between the multiple nodes 102 and 104. One example of the calendar server 112 is shown in FIG. 4 and described in more detail below. In some embodiments, the calendar server 112 facilitates a scheduling session between the calendar clients on the various nodes 102 and 104. Additionally, where more than two nodes and calendar clients are present within the calendaring system 100, the calendar server 112 may facilitate a single scheduling session among more than two nodes, or multiple calendar sessions between the same or different nodes within the calendaring system 100. It should be noted that the configurations of the nodes 102 and 104, the calendar clients, and the calendar server 112 are not limited to particular hardware or software implementations. For example, multiple chat servers 112 may be present within the calendaring system 100 to facilitate multiple simultaneous scheduling sessions.

When meeting invitations are transmitted, for example, from the sending node 102 to the receiving node 104, the invitations are parsed and may be displayed to users via the calendar user interfaces 108 and 110 at the corresponding nodes 102 and 104. Additionally, the meeting invitation transmissions may include information pertaining to the sending user, information pertaining to the receiving user, and other pertinent data such as scheduling information and data. This data can be extracted from the meeting invitation and optionally displayed by the calendar user interfaces 108 and 110. Examples of pertinent data include references to the sender and one or more recipients, by user name and/or network IP addresses. Pertinent data also can include a message subject, timestamps, or other similar data. Pertinent data also can include scheduling data, meeting locations, meeting topics, or other similar data.

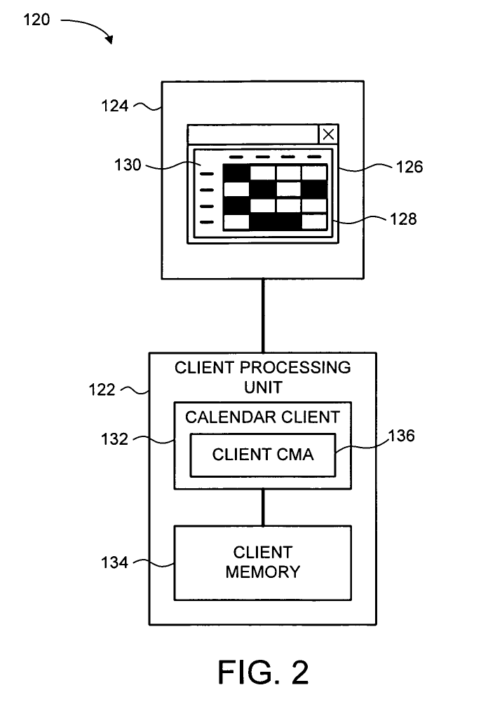

FIG. 2 depicts a schematic block diagram of one embodiment of a client computer 120 that is substantially similar to the nodes 102 and 104 of the calendaring system 100 of FIG. 1. The illustrated client computer 120 includes a client processing unit 122 and a display device 124. In some embodiments, the display device 124 displays a calendar user interface 126, similar to the calendar user interfaces 108 and 110 described above. In some embodiments, the calendar user interface 126 displays a scheduling session 128 and related scheduling data 130. In some embodiments, the scheduling data 130 includes such data as meeting times, meeting location, meeting topics, invited participants, etc.

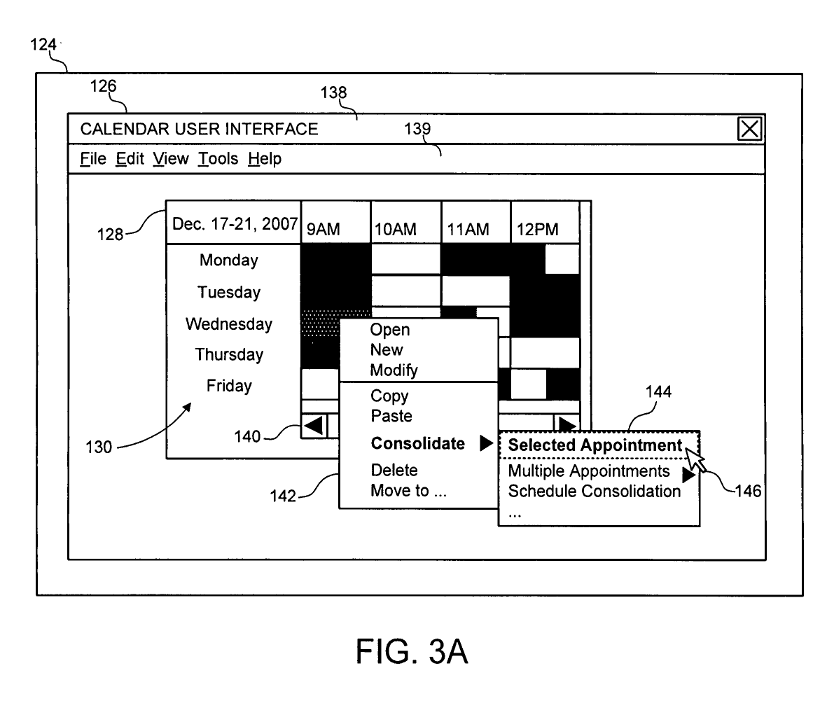

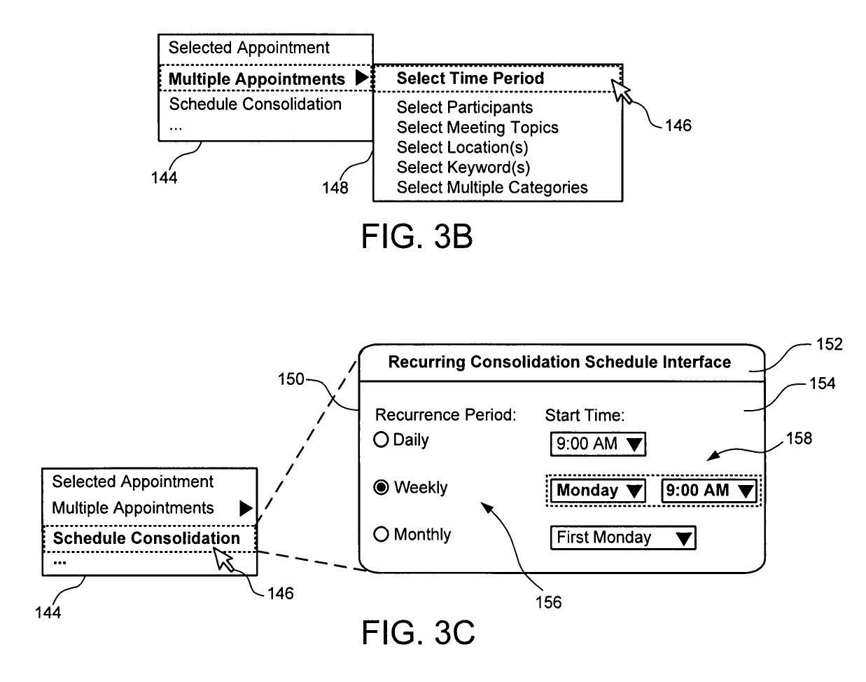

The client processing unit 122 includes a calendar client 132 and a client memory 134. Additionally, the calendar client 132 includes a client Calendar Management Agent (CMA) 136. The client memory 134 is coupled to the calendar client 132. The client memory 134 stores data related to the scheduling session 128. In one embodiment, the client memory 134 stores the scheduling data 130. One example implementation of a scheduling session 128 is shown in FIGS. 3A and 3B and described in more detail below. Some embodiments of the client memory 134 also store other data in addition to data related to a scheduling session 128 and the scheduling data 130 such as protocols and code associated with the functionality and operation of the client CMA 136. In some embodiments, the client memory 134 stores appointment data associated with the calendar client 132.

The calendar client 132 facilitates a scheduling session 128 on the client computer 120. As described above, the calendar server 112 facilitates several scheduling sessions between the local and remote calendar clients. The scheduling session 128 stored in the client memory 134 may be associated with a request to consolidate scheduled meetings. In some embodiments, the local calendar client 132 is configured to aggregate both local related scheduling data and remote related scheduling data from the calendar server 112. In this way, a user may view the scheduling session 128 and the scheduling data 130 on the display device 124 related to the user's schedule as well as other scheduling data related to other users.

As depicted, the client CMA 136 is coupled to the calendar client 132. The client CMA 136 facilitates a consolidation of scheduled meetings. In some embodiments, the client CMA 136 facilitates a consolidation of scheduled meetings in association with a scheduling session 128. For example, a user may instigate a consolidation session through the calendar user interface 126. Alternatively, the client CMA 136 facilitates a consolidation of scheduled meetings independent from a scheduling session 128 and/or the calendar user interface 126. For example, the client CMA 136 may allow a user to schedule a recurring consolidation session in regular intervals such as an exemplary schedule of running a consolidation session on the user's schedule every Monday morning. In some embodiments, the client CMA 136 allows a user to schedule a recurring consolidation session in intervals such as daily, weekly, monthly, etc. One example of implementation of a consolidation session is shown in FIGS. 3A and 3B and described in more detail below.

FIG. 3A depicts an exemplary embodiment of a calendar user interface 126 and a scheduling session 128 on the client computer of FIG. 2. Although certain components of the calendar user interface 126 and a scheduling session 128 are shown and described herein, other embodiments may implement fewer or more components and provide more or less functionality than the components shown in FIG. 3A. For example, some embodiments may display different scales and ranges for viewing a user's schedule such as a monthly view, a weekly view, and/or a daily view. Additionally, although the scheduling session 128 depicts a calendar in a grid format, other formats can also be implemented. For example, the scheduling session 128, in some embodiments, displays the calendar as a table, a list, multidimensional layers, graphical representation, and so forth.

In particular, FIG. 3A depicts the scheduling session 128 on the display device 124 of the client computer 120. As explained above, the scheduling data 130 and associated scheduling session 128 may be stored in the client memory 134 and displayed on the display device 124 for review by a user. Although the scheduling data 130 and scheduling session 128 of FIG. 3A is shown with specific content and a particular visual layout, other embodiments may provide more or less content and may use a different visual layout in one or more aspects.

As depicted, the calendar user interface 126 is displayed on the display device 124. The calendar user interface 126 includes a title bar 138, a menu bar 139, and the scheduling session 128. The title bar 138 depicts a title of the calendar user interface 126 and allows the user to exit the calendar user interface 126. The menu bar 139 depicts menu options for the calendar user interface 126 such as File, Edit, Help, etc. Additionally, the scheduling session 128 includes scheduling data 130, a scroll bar 140, and a right-click menu 142. The scroll bar 140 allows a user to scroll through the time slots of the calendar user interface 126.

The illustrated scheduling data 130 displays text data corresponding to scheduling information such as dates and times associated with scheduled meetings. Additionally, the scheduling data 130 may include a meeting location, a meeting topic, associated keywords, and participant profiles, including contact information, participant location, job title, areas of expertise, etc.

As depicted, the scheduling session 128 of FIG. 3A also includes a right-click menu 142, a consolidation menu 144, and a mouse cursor 146 clicking on an option of the consolidation menu 144. As an illustrated example, a user right-clicks on an existing appointment on Monday Dec. 17, 2007 at 9:00 A.M. By right-clicking on an existing appointment the user is allowed to request a consolidation session. More specifically, the consolidation menu 144 allows the user to consolidate the selected meeting with other scheduled meetings by choosing “Selected Appointment” option from the consolidation menu 144.

As depicted, the user clicks on the “Selected Appointment” option of the consolidation menu 144 of FIG. 3A which opens the selected appointment menu 148. By clicking on an option of the selected appointment menu 148, the user is allowed to assign certain criteria to the selected appointment consolidation session. For example, the selected appointment menu 148 may allow the user to select such options as time period, participants, meeting topics, locations, and keywords. Additionally, the selected appointment menu 148 may allow the user to select multiple categories from the selected appointment menu 148. In other words, a user may select the “Select Time Period” option from the selected appointment menu 148 to select a specific range of time associated with the search for consolidation candidates in the consolidation session. For example, the user may select a period of one week. Any scheduled meetings during the selected one week period are searched in order to find consolidation candidates. Alternatively, the user may select certain keywords to associate with the search for consolidation candidates in the consolidation session. The consolidation session then searches for matches between the user's selected meeting and other scheduled appointments containing the keywords provided by the user. Thus, the selected appointment menu 148 enables a user to start a consolidation session relative to the selected appointment. The selected scheduled meeting is then potentially consolidated with other scheduled meetings when a potential match is found. Additionally, the user may select a “Multiple Appointments” option from the consolidation menu 144.

FIG. 3B depicts an exemplary embodiment of the consolidation menu 144 for use with the calendar user interface 126 of FIG. 3A. In some embodiments, the scheduling session 128 is removable from the calendar user interface 126 such that a user can move the scheduling session 128 to various locations on the display device 124. Alternatively, in some embodiments, the consolidation menu 144 of FIG. 3B is embedded in the calendar interface 126, as shown in FIG. 3A. Although the consolidation menu 144 of FIG. 3B is shown with specific content and a particular visual layout, other embodiments may provide more or less content and may use a different visual layout in one or more aspects.

As depicted, the consolidation menu 144 of FIG. 3B includes the mouse cursor 146, and a multiple appointments menu 149 for selecting multiple appointments consolidation options. In other words, the multiple appointments menu 149 enables a batch mode in which several appointments in are searched simultaneously in a consolidation session for several potential consolidations. As depicted, a user selects an option from the multiple appointments menu 149 which is part of the consolidation menu 144. By selecting an option of the multiple appointments menu 149, a user is allowed to assign certain criteria to a multiple appointments consolidation session. In some embodiments, the multiple appointments menu 149 is substantially similar to the selected assignment menu 148 of FIG. 3B. Thus, in the multiple appointments menu 149, a user may select such options as time period, participants, meeting topics, locations, keywords, etc. Additionally, the multiple appointments menu 149 may allow the user to select multiple categories from the multiple appointments menu 149, similar to the selected appointment menu 148. Thus, the multiple appointments menu 149 enables a user to start a consolidation session for several appointments at once. Additionally, a user may select to regularly schedule a consolidation session such as the “Schedule Consolidation” option from the consolidation menu 144.

FIG. 3C depicts an exemplary embodiment of a recurring consolidation schedule interface 150 for use with the calendar user interface 126 of FIG. 3A. In particular, the recurring consolidation schedule interface 150 shows the details generated by the calendar user interface 126 within a graphical user interface (GUI) for display on a display device 124, in order to schedule a recurring consolidation session. It should be noted that other embodiments of the recurring consolidation schedule interface 150 may be integrated with other similar or new interfaces that are used to display related information. Although the recurring consolidation schedule interface 150 of FIG. 3C is shown with specific content and a particular visual layout, other embodiments may provide more or less content and may use a different visual layout in one or more aspects.

The illustrated recurring consolidation schedule interface 150 includes a title bar 152 and a recurring consolidation schedule interface message body 154. The title bar 152 shows a title of the recurring consolidation schedule interface 150. The recurring consolidation schedule interface message body 154 shows the details of the recurring consolidation schedule such as a recurrence period 156 and a start time 158. Hence, a user configuring a recurring consolidation schedule may select a recurrence period 156 such as daily, weekly, or monthly. As an exemplary selection, the user may select a “Weekly” recurrence period 156. Thus, a consolidation session would execute on a weekly basis according to the start time 158 selected by the user. As an exemplary selection, the user may select the start time 158 to be every Monday at 9:00 A.M. Thus, the consolidation session would execute on a weekly basis every Monday at 9:00 A.M. Alternatively, the user may select a different recurrence period 156 and a different start time 158 corresponding to the selected recurrence period 156. Thus, the recurring consolidation schedule interface 150 allows a user to perform batch consolidation requests on a recurring basis. Further details of the operations and functions of the consolidation session are described below with reference to FIG. 4.

FIG. 4 depicts a schematic block diagram of one embodiment of the calendar server 112 of the calendaring system 100 of FIG. 1. The illustrated calendar server 112 includes a server Calendar Management Agent (CMA) 160 and a server memory 162. The server CMA 160 includes a CMA reader 164, a CMA analyzer 166, and a CMA trigger 168. Additionally, the server memory 162 includes a CMA database 170. Although certain components of the calendar server 112 are shown and described herein, other embodiments may implement fewer or more components and provide more or less functionality than the components shown in FIG. 4.

In one embodiment, the calendar server 112 includes a dedicated calendar system and stores calendar data related to one or more users. In some embodiments, the calendar server 112 stores calendar data on the server memory 162. In some embodiments, the calendar server 112 is an interface for the server CMA 160 to query a main calendaring system running on a different server (not shown). In some embodiments, the calendar server 112 facilitates a scheduling session 128 between multiple calendar clients.

In one embodiment, the calendar server 112 facilitates a real-time scheduling consolidation between multiple calendar clients. In particular, the server CMA 160 may process consolidation related data that is sent between several calendar clients. In some embodiments, the server CMA 160 queries the calendaring systems of each user associated with the scheduling session 128 and synchronizes the calendaring data from each user's calendar client 132. In some embodiments, the server CMA 160 stores the synchronized calendaring data in the CMA database 170. More specifically, the server CMA 160 of the calendar server 112 may process consolidation requests that are sent from a client CMA 136 to the server CMA 160 over the network 106. In some embodiments, the server CMA 160 stores CMA related data on the server memory 162 such as code related to consolidation protocols, operations, and functions.

In one embodiment, the server CMA 160 processes requests to consolidate a scheduled meeting. In some embodiments, the server CMA 160 processes consolidation requests in association with the scheduling session 128. In some embodiments, the server CMA 160 processes consolidation requests associated with the scheduling session 128 in conjunction with the client CMA 136. For example, a user that is a chairperson of a scheduled meeting may request a consolidation of the scheduled meeting on the scheduling session 128. In some embodiments, the client CMA 136 of the user then communicates the request to the server CMA 160. The server CMA 160 processes the request, and, upon finding a consolidation match and consolidating the scheduled meetings, communicates the consolidation information to all of the client computers of other users associated with the consolidated meetings.

In one embodiment, the CMA reader 164 reads data stored in the CMA database 170 in response to the server CMA 160 receiving a request to consolidate a scheduled meeting. The CMA database 170, in some embodiments, includes participant profiles such as the user's name, job titles, contact information, work location, areas of expertise, etc. Additionally, the CMA database 170 may include information related to a scheduled meeting such as meeting time, meeting location, meeting duration, meeting topics, invited participants, etc. In some embodiments, the CMA reader 164 reads data stored in the CMA database 170 according to the criteria associated with a requested consolidation. For example, a user may request to perform a consolidation over a one month time period. In addition to the selected one month time period, the user may request consolidation for users A, B, and/or C in that one month time period. Additionally, as an exemplary meeting topic, the user may request to perform this consolidation for scheduled meetings with the topic of “Java development.” Thus, the CMA reader 164 would read the CMA database 170 for all scheduled meetings during the selected one month time period where users A, B, and/or C are invited participants, and containing the meeting topic “Java development.” The CMA reader 164 may then make the correlating data gathered from the CMA database 170 available to the CMA analyzer 166.

In one embodiment, the CMA analyzer 166 analyzes the data that the CMA reader 164 reads from the CMA database 170. In some embodiments, the CMA analyzer 166 analyzes the data in the CMA database 170 according to the criteria associated with the consolidation request, such as the criteria depicted in the selected appointment and multiple appointments menus 148 and 149 (time period, participants, meeting topics, etc.). In some embodiments, the CMA analyzer 166 compares the scheduling data 130 associated with a scheduled meeting with the scheduling data 130 associated with other scheduled meetings during a selected time period. When the CMA analyzer 166 finds a match between the scheduled meeting and another scheduled meeting, then the CMA trigger 168 includes the match as a consolidation proposal to the user.

In one embodiment, the CMA trigger 168 proposes a consolidation of scheduled meetings according to the results of the CMA analyzer's 166 analysis of the data read from the CMA database 170. In some embodiments, the CMA trigger 168 prompts a user to implement a consolidation of scheduled meetings. The CMA trigger 168 then consolidates the scheduled meetings into one scheduled meeting in response to the user's selection to implement the consolidation of the scheduled meetings. In some embodiments, the CMA trigger 168 displays on the display device 124 a list of consolidation proposals for a user to select from.

In some embodiments, the consolidated meeting may include several partial meetings. For example, the CMA trigger 168 may prompt a user to consolidate meeting A with meetings B and C. Meeting A may be originally scheduled on Monday at 9:00 AM for 30 minutes, meeting B at 1:00 PM the same day as meeting A for 30 minutes, and meeting C the same day as meeting A at 3:00 PM for 15 minutes. Additionally, users X, Y, and Z may be scheduled for meeting A, users X, Y, Q, and R for meeting B, and users X, Y, Z, and Q may be scheduled for meeting C. Thus, the CMA trigger 168, in one embodiment, proposes a meeting length of 75 minutes for the consolidation of meetings A, B, and C on Monday at 9:00 AM. Additionally, according to the arrangement of the participants, the CMA trigger 168 may propose to arrange the meetings such that meeting A is scheduled for the first 30 minutes of the consolidated meeting, meeting C is scheduled for the next 15 minutes of the consolidated meeting, and meeting B is scheduled for the final 30 minutes of the consolidated meeting. Thus, users X and Y are present for the entire 75 minutes of the consolidated meeting. User Z is present for the first and second segments of the consolidated meeting (meetings A and C). User Q is present for the last two segments of the consolidated meeting (meetings C and B), and user R is present for the final segment of the 75 minute consolidated meeting (meeting B).

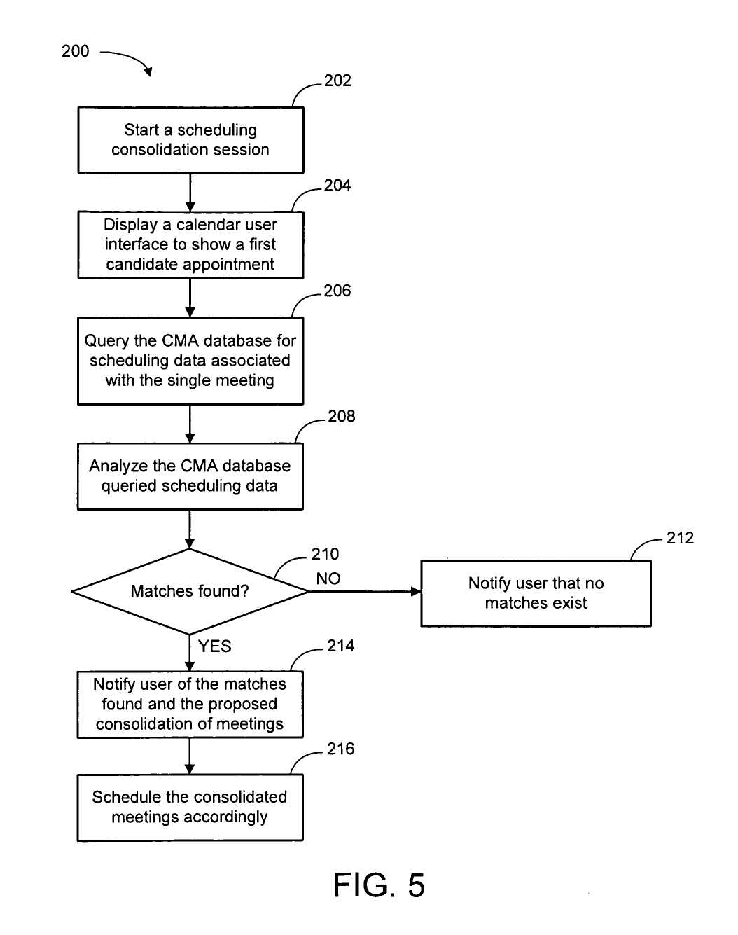

FIG. 5 depicts a schematic flow chart diagram of one embodiment of a scheduling consolidation method 200 for the consolidation of the single meeting with other associated meetings during a scheduling session 128. For ease of explanation, the scheduling consolidation method 200 is described with reference to the calendaring system 100 of FIG. 1 and, in particular, to the calendar server 112 of FIGS. 1 and 4. However some embodiments of the scheduling consolidation method 200 may be implemented with other calendaring systems.

In the illustrated scheduling consolidation method 200, a user starts 202 a scheduling consolidation session. A display device 124 displays 204 the calendar user interface 126 to show a first candidate appointment. In an exemplary embodiment, following the scheduling of a meeting, the user right-clicks on the scheduled meeting and selects the “Selected Appointment” option of the consolidation menu 144. The server CMA 160 then initiates a consolidation session to consolidate the selected appointment. Alternatively, in some embodiments, the server CMA 160 prompts a user to consolidate a scheduled meeting whenever the user creates a new appointment.

In some embodiments, the server CMA 160 prompts the user to provide a specific time period within which the server CMA 160 will search for scheduling data 130 that correlates with the scheduling data 130 of the selected appointment. In other words, the server CMA 160 may prompt the user to provide a specific time period, and, as an exemplary selection, the user may enter a time period of the next 30 days. Thus, the server CMA 160 would perform a batch consolidation session between the single meeting and all the other scheduled meetings in the user's schedule that are scheduled within the next 30 days.

In response to a request to perform a consolidation session, the CMA reader 164 queries 206 the CMA database 170 for scheduling data 130. In one embodiment, the scheduling data includes lists of invited participants, appointment times and dates, appointment topics, and appointment locations for the first and second candidate appointments. In other words, the server CMA 160 in conjunction with the CMA reader 164 searches for a second candidate appointment for consolidation with the first candidate appointment based on at least one consolidation parameter. In one embodiment, the consolidation parameter includes a time selection, a participant selection, a meeting topics selection, a location selection, a keyword selection, and a multiple parameters selection

In one embodiment, the CMA analyzer 166 analyzes 208 the scheduling data 130 queried by the CMA reader 164 from the CMA database 170. In some embodiments, the CMA reader 164 analyzes the queried scheduling data 130 for potential consolidation matches. In some embodiments, the CMA analyzer 166 compares the scheduling data 130 associated with the other scheduled meetings and the scheduling data 130 of the single meeting. The CMA analyzer 166 determines 210 whether the queried scheduling data 130 of the other scheduled meetings contains any consolidation matches with the scheduling data 130 of the single meeting. When the CMA analyzer 166 determines that the queried scheduling data 130 does not contain any consolidation matches, the server CMA 160 notifies 212 the user that no matches exist. Otherwise, the server CMA 160 notifies 214 the user of the matches found between the other scheduled meetings and the single meeting. In some embodiments, the notification includes a list of one or more proposed meeting consolidations. In other words, the server CMA 160 may discover more than one potential consolidation, and may list the different possibilities as a list of potential consolidated meetings. The user may then select a consolidation of meetings from the list of the potential consolidated meetings.

At block 216, the CMA trigger 168 then schedules the consolidated meetings according to the selection of the user. In some embodiments, the CMA trigger 168 then sends notifications to each participant associated with the consolidated meetings, notifying the users of the consolidated meetings and any rescheduling associated with the consolidated meetings. In some embodiments, the CMA trigger 168 orders the consolidated meetings according to the scheduling data 130 of the consolidated meetings such as matching participants, matching topics, etc. For example, as explained above, the CMA trigger 168 may consolidate several scheduled meetings such as meetings A, B, and C. However, if a user Z is invited to meetings A and C only, then the CMA trigger 168 may order the meetings A, C, and B so that user Z is able to leave after the conclusion of meetings A and C, thus improving the efficiency of the consolidated meetings.

It should also be noted that at least some of the operations for the method 200 may be implemented using software instructions stored on a computer useable storage medium for execution by a computer. As an example, an embodiment of a computer program product includes a computer useable storage medium to store a computer readable program that, when executed on a computer, causes the computer to perform operations. In one embodiment, the operations include an operation to display a calendar user interface to show a first candidate appointment. The operations also include an operation to search for a second candidate appointment for consolidation with the first candidate appointment based on at least one consolidation parameter. The operations also include an operation to identify a consolidated appointment for at least the first and second candidate appointments. The consolidated appointment combines the first and second candidate appointments according to the consolidation parameter. Other embodiments of the computer program product may include operations to implement additional functionality, as described herein.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times the code is retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising a computer useable storage medium to store a computer readable program that, when executed on a computer, causes the computer to perform operations of a scheduling consolidation session, the operations comprising:
display a calendar user interface to show a first candidate appointment;
search for a second candidate appointment for consolidation with the first candidate appointment based on at least one consolidation parameter; and
identify a consolidated appointment for at least the first and second candidate appointments, wherein the consolidated appointment combines the first and second candidate appointments according to the consolidation parameter.

2. The computer program product of claim 1, wherein the computer readable program, when executed on the computer, causes the computer to perform further operations comprising:
read scheduling data related to the first and second candidate appointments from a calendar management agent (CMA) database, wherein the scheduling data comprises lists of invited participants, appointment times and dates, and appointment locations for the first and second candidate appointments;
compare the scheduling data associated with the first candidate appointment with the scheduling data associated with the second candidate appointment; and
identify a scheduling match between the first and second candidate appointments to identify the consolidated appointment according to the consolidation parameter.

3. The computer program product of claim 2, wherein the computer readable program, when executed on the computer, causes the computer to perform further operations comprising:
read a first appointment topic related to the first candidate appointment and a second appointment topic related to the second candidate appointment from the CMA database, wherein the scheduling data also comprises appointment topics for the first and second candidate appointments;
compare the first appointment topic associated with the first candidate appointment with the second appointment topic associated with the second candidate appointment; and
identify a scheduling match between the appointment topics of the first and second candidate appointments to identify the consolidated appointment.

4. The computer program product of claim 1, wherein the computer readable program, when executed on the computer, causes the computer to perform operations comprising:
display a proposal of the consolidated appointment of the first and second candidate appointments to a user;
consolidate a first and second candidate appointments according to the consolidated appointment based on a selection by the user; and
notify a participant associated with either of the first and second candidate appointments of the consolidated appointment.

5. The computer program product of claim 1, wherein the computer readable program, when executed on the computer, causes the computer to perform operations further comprising schedule a recurring consolidation session, wherein the recurring consolidation session executes repeatedly in regularly scheduled intervals to identify additional consolidated appointments for additional candidate appointments.

6. The computer program product of claim 1, wherein the computer readable program, when executed on the computer, causes the computer to perform operations further comprising perform a batch scheduling consolidation session, wherein the batch scheduling consolidation session comprises searching the CMA database to determine if a match exists for any of a plurality of appointments in the CMA database.

7. The computer program product of claim 1, wherein the computer readable program, when executed on the computer, causes the computer to perform operations further comprising define the at least one consolidation parameter, wherein the at least one consolidation parameter comprises a time selection, a participant selection, a meeting topics selection, a location selection, a keyword selection, and a multiple parameters selection.

8. A system comprising:
a client computer to display a calendar user interface to show a first candidate appointment; and
a calendar server coupled to the client computer, the calendar server to facilitate a scheduling consolidation session, wherein the calendar server comprises:
a server calendar management agent (CMA) to search for a second candidate appointment for consolidation with the first candidate appointment based on at least one consolidation parameter and to identify a consolidated appointment for at least the first and second candidate appointments, wherein the consolidated appointment combines the first and second candidate appointments according to the consolidation parameter.

9. The system of claim 8, wherein the server CMA further comprises a CMA reader, the CMA reader to read scheduling data stored in a CMA database in conjunction with the scheduling consolidation session, wherein the scheduling data comprises lists of invited participants, appointment times and dates, and appointment locations for the first and second candidate appointments.

10. The system of claim 9, wherein the CMA reader is further configured to read a first appointment topic related to the first candidate appointment and a second appointment topic related to the second candidate appointment from the CMA database, wherein the scheduling data also comprises appointment topics for the first and second candidate appointments

11. The system of claim 10, wherein the server CMA further comprises a CMA analyzer, the CMA analyzer to analyze the scheduling data from the CMA database and to compare the scheduling data associated with the first candidate appointment to the scheduling data associated with the second candidate appointment base on the at least one consolidation parameter, wherein the at least one consolidation parameter comprises a time selection, a participant selection, a meeting topic selection, a location selection, a keyword selection, and a multiple parameters selection.

12. The system of claim 11, wherein the server CMA further comprises a CMA trigger, the CMA trigger to identify a scheduling data match between the first and second candidate appointments, to propose the consolidated appointment of the first and second candidate appointments to a user based on the scheduling data match, to consolidate the first and second candidate appointments in response to a selection by the user, and to notify a participant associated with either of the first and second candidate appointments of the consolidated appointment.

13. The system of claim 8, wherein the server CMA is further configured to define a time period in conjunction with the scheduling consolidation session, wherein the time period specifies a range of time in which a plurality of appointments are scheduled.

14. The system of claim 8, wherein the client computer comprises a display device, the display device to display the calendar user interface and the consolidated appointment to the user.

15. A method comprising:
displaying a calendar user interface to show a first candidate appointment;
searching for a second candidate appointment for consolidation with the first candidate appointment based on at least one consolidation parameter; and
identifying a consolidated appointment for at least the first and second candidate appointments, wherein the consolidated appointment combines the first and second candidate appointments according to the consolidation parameter.

16. The method of claim 15, further comprising:
reading scheduling data related to the first and second candidate appointments from a calendar management agent (CMA) database, wherein the scheduling data comprises lists of invited participants, appointment times and dates, and appointment locations for the first and second candidate appointments;
comparing the scheduling data associated with the first candidate appointment with the scheduling data associated with the second candidate appointment; and
identifying a scheduling match between the first and second candidate appointments to identify the consolidated appointment according to the consolidation parameter.

17. The method of claim 15, further comprising:
displaying a proposal of the consolidated appointment of the first and second candidate appointments to a user; and
consolidating a first and second candidate appointments according to the consolidated appointment based on a selection by the user.

18. The method of claim 15, further comprising notifying a participant associated with either of the first and second candidate appointments of the consolidated appointment.

19. An apparatus comprising:
means for displaying a calendar user interface to show a first candidate appointment;
means for searching for a second candidate appointment for consolidation with the first candidate appointment based on at least one consolidation parameter; and
means for identifying a consolidated appointment for at least the first and second candidate appointments, wherein the consolidated appointment combines the first and second candidate appointments according to the consolidation parameter.

20. The apparatus of claim 19, further comprising:
means for reading scheduling data related to the first and second candidate appointments from a calendar management agent (CMA) database, wherein the scheduling data comprises lists of invited participants, appointment times and dates, and appointment locations for the first and second candidate appointments;
means for comparing the scheduling data associated with the first candidate appointment with the scheduling data associated with the second candidate appointment;
means for identifying a scheduling match between the first and second candidate appointments to identify the consolidated appointment according to the consolidation parameter;
means for displaying a proposal of the consolidated appointment of the first and second candidate appointments to a user;
means for consolidating a first and second candidate appointments according to the consolidated appointment based on a selection by the user; and
means for notifying a participant associated with either of the first and second candidate appointments of the consolidated appointment.
